(19) United States
(12) Patent Application Publication
(10) Pub. No.: US 2011/0277844 A1
(43) Pub. Date: Nov. 17, 2011

(54) POLYMERS DERIVED FROM N-VINYL FORMAMIDE, VINYL AMIDES OR ACRYLAMIDES, AND REACTION SOLVENT, AND THE USES THEREOF

(76) Inventors: Osama M. Musa, Kinnelon, NJ (US); Cuiyue Lei, Wayne, NJ (US); Kolazi S. Narayanan, Wayne, NJ (US)

(21) Appl. No.: 13/129,007

(22) PCT Filed: Nov. 13, 2009
(86) PCT No.: PCT/US09/64299

§ 371 Date: Jul. 29, 2011

Related U.S. Application Data
(60) Provisional application No. 61/114,165, filed on Nov. 13, 2008.

(51) Int. Cl. F15D 1/00; C08F 226/08; C08L 79/04; C08F 226/06

(52) U.S. Cl. 137/1; 526/264; 524/548; 523/122

(57) ABSTRACT

Polymers are provided that are derived from at least (A) N-vinyl formamide, (B) one vinyl amide moiety or one acrylamide moiety, and (C) a reaction solvent. The polymers are random, block, or alternating polymers. A particular useful poly-mer comprises about 20% N-vinyl formamide, about 50% N-vinyl-ε-caprolactam, about 30% N-vinyl-2-pyrrolidone, being synthesized in ethylene glycol. In preferred embodiments, polymers of the invention exhibit a cloud point temperature of 66° C. or more, inhibit the formation of gas hydrates, and/or inhibit corrosion. Especially preferred uses of the polymers are in oilfield operations as gas hydrate inhibitors and/or corrosion inhibitors.

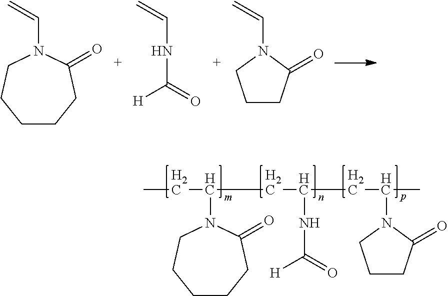

### FIELD OF THE INVENTION

The invention relates to polymers that are derived from at least: N-vinyl formamide, one vinyl amide moiety or one acrylamide moiety, and a reaction solvent capable of forming an adduct. Surprisingly, these polymers have been discovered to possess exceptionally high cloud point temperatures and inhibitory properties against the formation of gas hydrates and corrosion.

Due to these properties, the polymers and compositions thereof find application in a wide range of fields, including oilfield operations where they may be used for gas hydrate and/or corrosion inhibition. The attributes of the polymers lend themselves to other arts, including (but not limited to): other performance chemicals applications (e.g., adhesives, agricultural chemicals, biocides, cleaning, coating, electronics, encapsulation, membrane, microelectronics, sealant, and sensor applications), and personal care applications. The polymers also may be used for the deposition of actives, like biocides and fragrances, across these applications segments.

### DESCRIPTION OF THE PRIOR ART

The extraction and fluid transport of oil and natural gas present many challenges. Of primary concern in this invention is the inhibition of corrosion and gas hydrate formation in the extraction pipeline. It is well known that the presence of water in the hydrocarbon-containing line can facilitate the formation of gas hydrate crystals and/or corrosion, which can block the conduit and/or compromise the integrity of the construction materials. Lower molecular weight hydrocarbon gases such as methane, ethane, propane, butane, and isobutane are especially prone to the formation of gas hydrates. Elevated pressures and low temperatures aide interactions between the dissolved hydrocarbon(s) and water. Additionally, corrosion can be accelerated when brine or acidified water (i.e., containing dissolved hydrogen sulfide or carbon dioxide) is encountered. Such process conditions are frequently encountered, especially during deep sea and arctic drilling, causing these molecules to nucleate, crystallize, and produce gas hydrate crystals. The formation, persistence, and accumulation of gas hydrates during drilling and transport operations to the processing facility may result in large pressure drops and/or extensive cost and downtime if they impede fluid transport.

Methods have been developed to address these problems, and can be categorized into four general areas: (1) water removal from the transport line, (2) thermal approaches to maintain and/or create a temperature profile inside the transport line so that gas hydrate formation is unfavorable, (3) thermodynamic chemical (antifreeze compounds) addition to elevate the gas hydrate crystallization temperature, and (4) kinetic chemical addition to retard, delay, or slow gas hydrate nucleation kinetics and retard, delay, or slow their agglomeration after they form. However, all methods are prone to problems, such as the flammability and toxicity of methanol as a thermodynamic inhibitor and cost of insulation and dehydration. Thus, there is the need for improved methods of maintaining pipelines free of gas hydrate crystal and providing corrosion inhibition.

The prior art discloses kinetic inhibitors of gas hydrates, for which polymeric compositions have proved especially beneficial. Representative compositions include those disclosed in the following U.S. Pat. Nos. 4,915,176; 5,420,370; 5,432,292; 5,639,925; 5,723,524; 6,028,233; 6,093,863; 6,096,815; 6,117,929; 6,451,891; and 6,451,892. Many of these compositions comprise cyclic ring members, such as lactam rings.

While useful, these materials have their limitations. For examples, the prior art teaches a trade-off between kinetic hydrate inhibition performance and cloud point temperature. For example, polyvinylpyrrolidone homopolymer, which contains a plurality of five-member lactam rings, possesses a cloud point temperature in excess of 100° C., but is a poor kinetic hydrate inhibitor. Heteropolymers of vinylpyrrolidone offer improved kinetic hydrate inhibition, but possess a lower cloud point than polyvinylpyrrolidone homopolymer. Furthermore, polyvinylpyrrolidone homopolymer is not an inhibitor for corrosion.

Polymeric gas hydrate inhibitors comprising a heterocyclic organic ring (e.g., N-vinyl-2-pyrrolidone, N-vinyl-ε-caprolactam) and a noncyclic amide are taught in U.S. Pat. No. 5,639,925. This patent discloses clathrate hydrate inhibitors for hydrocarbon-containing fluids, especially those fluids less than 45° C., and “preferably, the fluid is subjected to a temperature of lower than 40° F.” In practice, the ability of the polymeric gas hydrate inhibitor to resist phase separation at higher temperatures (i.e., a high cloud point) is important during many stages of fluid transport, e.g., deep subterranean extraction and transport in topical waters. The '925 patent is silent on cloud point and corrosion inhibition, and how polymeric composition affects these two important properties.

N-vinyl formamide homopolymers or copolymers thereof are taught as gas hydrate inhibitors in WO 99/64717. The effects of reaction solvent on the properties of these hydrate inhibitors are not provided, nor is any discussion of corrosion inhibition described.

Specification for the reaction solvent is provided in U.S. Pat. No. 6,451,891, wherein desired solvents include low molecular weight glycol ethers containing an alkoxy group having at least three carbon atoms. The gas hydrate inhibitors claimed in that patent are not known to provide corrosion inhibition.

Dual corrosion- and gas hydrate inhibitors are the discussed in U.S. Pat. No. 7,341,617. The polymeric compositions comprise quaternary alkylaminoalkyl/alkoxy esters and quaternary alkylaminoalkyl/alkoxy amides of dicarboxylic acids. There is no mention of N-vinyl formamide, and there is no benefit taught of the cloud point temperature of these compositions.

US patent application 2003/0018152 discloses a method for producing polymers with a solvent for monomers and a second, different solvent for the polymerization solvent. The method is suitable for the production of gas hydrate inhibition polymers. Polymeric corrosion inhibitors are not disclosed.

Inhibitors of clathrate hydrates are the object of US patent application 2006/0205603. The polymeric clathrate hydrate inhibitors possess a bimodal distribution in molecular weight of a water-soluble polymer. Again, this application does not reveal any advantage to corrosion inhibition.

Despite the advances in gas hydrate and corrosion inhibitors, there persists the need for compositions that combine these dual attributes, and especially those inhibitors that do not phase-separate at high fluid temperatures.

### SUMMARY OF THE INVENTION

The present invention defines a new class of polymers derived from at least (A) N-vinyl formamide, (B) one vinyl amide moiety or one acrylamide moiety, and (C) a reaction solvent capable of forming an adduct. The polymers find application in a variety of fields, including, but not limited to: gas hydrate and corrosion inhibition, personal care (e.g., skin care, hair care), and delivery systems (e.g., biocides, fragrances) of enhanced deposition.

The disclosed polymers of the invention display a number of desirable properties, such as: gas hydrate induction times of about 24 hours or more at 4° C. and 35 bar; and/or 7° C. and 60 bar; exceptionally high cloud point temperatures of about 66° C. or more, and corrosion inhibition. Especially preferred polymers have a cloud point temperature of 80° C. or more, and most preferably 90° C.

In one embodiment of the invention, the polymers find use during oilfield operations and in oilfield compositions, where they may (a) inhibit and/or retard the formation of gas hydrates in a hydrocarbon pipeline, and/or (b) prevent corrosion of process equipment and/or fluid transport lines. The high cloud point temperatures of the discovered polymers make them particularly attractive for these uses.

In a related embodiment, a method is provided for inhibiting corrosion and gas hydrates in systems comprising a hydrocarbon-water composition.

### DETAILED DESCRIPTION OF THE INVENTION

As used herein, the following terms have the meanings set out below:

The term copolymer, designated by “-co-” in a polymer name, refers to a polymer that comprises two different repeating monomer units. The term terpolymer, designated by “-ter-” in a polymer name, refers to a polymer that comprises three different repeating monomer units

The term free radical addition polymerization initiator refers to a compound used in a catalytic amount to initiate a free radical addition polymerization. The choice of initiator depends mainly upon its solubility and its decomposition temperature.

The term oilfield operation is any activity related to the production or use of hydrocarbon-based fuels, such as exploring, discovering, drilling, extracting, delivering, and refining of oil and gas, as well as the termination and remediation of such operations.

The term oilfield compositions refers to compositions that are useful during oilfield operations. Oilfield compositions include anti-agglomerants, emulsifiers, de-emulsifiers, gas hydrate inhibitors, kinetic hydrate inhibitors, shale swelling inhibitors, and/or scale inhibitors.

The term performance chemicals composition refers to non-personal care compositions that serve a broad variety of applications, and include nonlimiting compositions such as: adhesives; agricultural, biocides, coatings, electronics, household-industrial-institutional (HI&I), inks, membranes, metal fluids, oilfield, paper, paints, plastics, printing, plasters, and wood-care compositions.

The term personal care composition refers to such illustrative non-limiting compositions as skin, sun, oil, hair, cosmetic, and preservative compositions, including those to alter the color and appearance of the skin. Potential personal care compositions include, but are not limited to, polymers for increased flexibility in styling, durable styling, increased humidity resistance for hair, skin, and color cosmetics, sun care water-proof/resistance, wear-resistance, and thermal protecting/enhancing compositions.

All percentages, ratio, and proportions used herein are based on a weight basis unless other specified.

### Polymer Description

The invention relates to polymers that are derived from at least: N-vinyl formamide, one vinyl amide moiety or one acrylamide moiety, and a reaction solvent capable of forming an adduct. Such polymers have at least two repeating monomer units, the first being N-vinyl formamide and second being a vinyl amide moiety or a acrylamide moiety. The polymer may be a random, block, or alternating polymer.

As will be discussed in detail in later sections, such polymers display desirable properties that make them attractive to numerous application arts. In particular, the polymers exhibit gas hydrate inhibition, exceptionally high cloud points of about 66° C. or more, more preferably 80° C. or more, and most preferably 90° C. or more, and corrosion inhibition. These properties find use in many performance chemicals and personal care compositions and uses thereof, especially during high temperature operations and applications where polymers may give evidence of partial or complete phase separation, for example, in oilfield operations and oilfield compositions.

It follows that the invention also provides methods of inhibiting gas hydrate formation and corrosion through the use of compositions comprising these polymers.

As described earlier, polymers of the invention derive in part from N-vinyl formamide, which is a polymerizable monomer that is well-known to those skilled in the art.

Polymers of the invention also are derived from at least one vinyl amide moiety or one acrylamide moiety. Of course, polymers may be synthesized to contain both moieties or additional polymerizable monomers.

Examples of exemplary cyclic vinyl amide moieties include, but are not limited to: N-vinyl-2-pyrrolidone, alkylated N-vinyl-2-pyrrolidones, N-vinyl-ε-caprolactam; N-vinyl-2-piperidone; N-vinyl-3-methylpyrrolidone; N-vinyl-4-methylpyrrolidone; N-vinyl-5-methylpyrrolidone; N-vinyl-3-ethyl pyrrolidone; N-vinyl-3-butyl pyrrolidone; N-vinyl-3,3-dimethyl pyrrolidone; N-vinyl-4,5-dimethyl pyrrolidone; N-vinyl-5,5-dimethyl pyrrolidone; N-vinyl-3,3,5-trimethyl pyrrolidone; N-vinyl-5-methyl-5-ethyl pyrrolidone; N-vinyl-3,4,5-trimethyl-3-ethyl pyrrolidone; N-vinyl-6-methyl-2-piperidone; N-vinyl-6-ethyl-2-piperidone; N-vinyl-3,5-dimethyl-2-piperidone; N-vinyl-4,4-dimethyl-2-piperidone; N-vinyl-6-propyl-2-piperidone; N-vinyl-3-octyl piperidone; N-vinyl-7-methyl caprolactam; N-vinyl-7-ethyl caprolactam; N-vinyl-4-isopropyl caprolactam; N-vinyl-5-isopropyl caprolactam; N-vinyl-4-butyl caprolactam; N-vinyl-5-butyl caprolactam; N-vinyl-4-butyl caprolactam; N-vinyl-5-tert-butyl caprolactam; N-vinyl-4-octyl caprolactam; N-vinyl-5-tert-octyl caprolactam; N-vinyl-4-nonyl caprolactam; N-vinyl-5-tert-nonyl caprolactam; N-vinyl-3,7-dimethyl caprolactam; N-vinyl-3,5-dimethyl caprolactam; N-vinyl-4,6-dimethyl caprolactam; N-vinyl-3,5,7-trimethyl caprolactam; N-vinyl-2-methyl-4-isopropyl caprolactam; and N-vinyl-5-isopropyl-7-methyl caprolactam.

Exemplary acyclic vinyl amide moieties include, but are not limited to: N-vinyl acetamide; N-propenylacetamide; N-(2-methylpropenyl)acetamide; N-vinyl formamide; N-(2,2-dichloro-vinyl)-propionamide; N-ethenyl acetamide; N-vinyl-N-methyl acetamide; and N-vinyl-N,N-propyl propionamide.

Likewise, cyclic acrylamide moieties include, but are not limited to: N-acryloyl pyrrolidone; N-acryloyl caprolactam; N-acryloyl piperidone; ethyl acryloyl pyrrolidone; methyl acryloyl pyrrolidone; ethyl acryloyl caprolactam; and methyl acryloyl caprolactam.

Finally, acyclic acrylamide moieties include, but are not limited to: acrylamide; N-ethylacrylamide; isopropyl acrylamide; N,N-diethylacrylamide; N-cyclohexylacrylamide, N-cyclopentylacrylamide; N-butoxymethylacrylamide; N,N-dibutylacrylamide; N-butylacrylamide; diacetoneacrylamide; N—(N,N-dimethylamino)ethyl acrylamide; N,N-diethylacrylamide; N,N-dimethylacrylamide; N-dodecylmethacrylamide; N-ethylacrylamide; N-ethylmethacrylamide; N-isopropylacrylamide; N-isopropylmethacrylamide; β,β-N,N-tetramethylacrylamide; N-methylolacrylamide; N-methyl acrylamide; N-octadecylacrylamide; N-octylacrylamide; N-phenylacrylamide; and trichloroacrylamide.

Since both N-vinyl formamide and described moieties are polymerizable units, there is no restriction on the ratio of these units in the final polymer. For example, the polymer may comprise a preponderance N-vinyl formamide or vinyl amide moiety/acrylamide moiety. In other words, the ratio of these two groups may range from about 1%-99% N-vinyl formamide to 1%-99% vinyl amide moiety/acrylamide moiety. The exact ratio used will depend on a number of factors, as described later.

The polymerization between N-vinyl formamide and vinyl amide moiety/acrylamide moiety is performed in a reaction solvent having either a hydroxyl group or a thiol group, or blends comprising such solvents. These polymerization reaction solvents are employed because they are capable of being incorporated into the polymer as a solvent adduct during polymerization. Without being bound to specific theory, it is believed that such reaction solvents promote a greater extension of polymer molecules in solution, improve the solubility of the polymer in aqueous solution, promote solubilization, and/or enhance polymer compatibility at high injection temperature (i.e., not phase-separate). For example, when the solvent comprises a lactam, such as N-hydroxymethyl-2-caprolactam or N-hydroxyethyl-2-pyrrolidone, then the solvent adduct may assist in enhancing the polymer's properties, such as solubilization, or more specifically, gas hydrate inhibition.

Again, not to be bounded by theory, it is also believed that the solvent adduct may impart surfactant-like properties to cause an extended polymer conformation in solution, which presumably exposes more of the polymer molecule to interact with the hydrate crystal lattice. Such surfactancy may be imparted by selecting a polymerization reaction solvent having either a hydroxyl group or a thiol group and sufficient hydrophilic-to-hydrophobic character. Such polymerization reaction solvents are contemplated to include (without limitation) alcohols including the alkyl hydroxides (e.g., methanol, ethanol, butanols, pentanols, and hexanols including cyclohexanol), and N-hydroxyalkyl lactams (e.g., N-hydroxymethyl-2-caprolactam or N-hydroxyethyl-2-pyrrolidone).

It is believed that the contribution(s) from the solvent adduct to the polymer's properties increase(s) as the polymer molecular weight decreases, since the molar fraction of solvent adduct is greater. This aspect favors the customization of lower molecular weight polymers, since their properties may be adjusted by selecting monomer and solvent species. Nonetheless, it is recognized that the presence of one or more solvent adducts into a polymer confers new chemistry into the molecule, which also may be exploited in higher molecular weight polymers as well.

Further examples of suitable water-soluble reaction solvents include: alcohols (e.g., butanol, 1-propanol, 2-propanol, propylene glycol, ethylene glycol), furans (e.g., tetrahydrofuran), glycol ethers (e.g., 2-methoxyethanol, 2-ethoxyethanol, 2-propoxyethanol, and 2-butoxyethanol), and thiols.

Preferred alcohols include ethanol, methanol, hydroxymethyl-2-caprolactam and N-hydroxyethyl-2-pyrrolidone.

An exemplary diol is ethylene glycol.

An exemplary glycol ether reaction solvent is 2-butoxyethanol.

Preferred thiols include methanethiol and ethanethiol.

In one embodiment of the invention, the polymerization reaction solvent also is employed for delivery. Less preferably, the polymerization is performed in one solvent, that solvent removed, and then the preferred solvent or blends of preferred solvents added.

The aforementioned polymers have a molecular weight from about 500 atomic mass units (amu) to about 5,000,000 amu, and the molecular weight may be chosen as appropriate for the end application. For example, polymers used in oilfield operations and compositions typically have molecular weights from about 500 amu to about 1,000,000 amu. Within the oilfield arts, polymers used to control the formation and/or growth of gas hydrates typically have a molecular weight from about 500 amu to 30,000 amu, whereas for salt thickening and shale swell inhibition higher molecular weight polymers, i.e., approaching 1,000,000 amu, are preferred.

### Preferred Polymers for Oilfield Applications

Polymers of the invention may be tailored for oilfield applications, where high injection temperature and gas hydrate inhibition are two primary properties of paramount importance.

As it will be seen in the Examples section, the cloud point of N-vinyl-ε-caprolactam homopolymer was measured to be 40° C. Discovered were polymers of substantially higher cloud point, created by polymerizing N-vinyl formamide and N-vinyl-ε-caprolactam in a adduct-forming solvent (e.g., ethylene glycol), and by polymerizing N-vinyl formamide, N-vinyl-ε-caprolactam, and N-vinyl-2-pyrrolidone in a adduct-forming solvent (e.g., ethylene glycol). Customization of the polymers is possible to one skilled in the art by selecting the moiety(ies) to be polymerized with N-vinyl formamide, choosing their ratio, and the reaction solvent. By doing so, cloud point temperatures or 66° C. or higher were produced. Other polymers of the Examples possess a cloud point temperature of 80° C. or more, while other polymers have a cloud point temperature of 90° C. or more. These properties have created much customer interest for the use of these polymers, especially in oilfield operations and compositions.

The increase in cloud point temperature is due, in part, to the incorporation of N-vinyl formamide, the homopolymer of which has a cloud point temperature in excess of 99° C. However, most surprisingly, exceedingly high levels of N-vinyl formamide were not required in order to impart high cloud point temperature into the discovered polymers. Rather, the described high cloud point temperature polymers contain no more than 50% N-vinyl formamide.

For example, non-homopolymers especially suited to oilfield applications were created that did not have an observable cloud point (because the solutions first boiled). While the molecular weight of these non-homopolymers is modestly greater than the corresponding N-vinyl-ε-caprolactam homopolymer, the work of Jurek et al. (2008) indicated that molecular weight alone cannot significantly alter the cloud point. Instead, the increase of cloud point temperature is attributed to the incorporation of hydrophilic monomer units into the polymer backbone.

In addition to high cloud point, polymers of the invention provide excellent gas hydrate inhibition. Gas hydrate induction times exceeding 48 h (and in one case exceeding 96 h) were measured for polymers based on N-vinyl-ε-caprolactam and N-vinyl formamide synthesized in ethylene glycol or 2-butoxyethanol; and polymers based on N-vinyl-ε-caprolactam, N-vinyl-2-pyrrolidone, and N-vinyl formamide synthesized in ethylene glycol. This result is surprising, as the incorporation of N-vinyl formamide, which is not known as a gas hydrate inhibitor, was expected to sacrifice gas hydrate inhibition. Thus, polymers of the invention that can be designed for combined high cloud point temperature and extended gas hydrate inhibition are expected to be useful in oilfield applications as well as other applications where one or both of these properties are desired.

### Polymer Synthesis

Methods to produce the polymers are known to one skilled in the art, and include free radical polymerization, emulsion polymerization, ionic chain polymerization, and precipitation polymerization, the methods of which are known to one skilled in the art. Free radical polymerization is a preferred polymerization method, and is described in “Decomposition Rate of Organic Free Radical Polymerization” by K. W. Dixon (section II in Polymer Handbook, volume I, 4^{th} edition, Wiley-Interscience, 1999), which is incorporated by reference.

Compounds capable of serving as a free radical addition polymerization initiator includes those materials known to function in the prescribed manner, and include the peroxo and azo classes of materials. Exemplary peroxo and azo compounds include, but are not limited to: acetyl peroxide; azo bis-(2-amidinopropane) dihydrochloride; azo bis-isobutyronitrile; 2,2′-azo bis-(2-methylbutyronitrile); benzoyl peroxide; di-tert-amyl peroxide; di-tert-butyl diperphthalate; butyl peroctoate; tert-butyl dicumyl peroxide; tert-butyl hydroperoxide; tert-butyl perbenzoate; tert-butyl permaleate; tert-butyl perisobutylrate; tert-butyl peracetate; tert-butyl perpivalate; para-chlorobenzoyl peroxide; cumene hydroperoxide; diacetyl peroxide; dibenzoyl peroxide; dicumyl peroxide; didecanoyl peroxide; dilauroyl peroxide; diisopropyl peroxodicarbamate; dioctanoyl peroxide; lauroyl peroxide; octanoyl peroxide; succinyl peroxide; and bis-(ortho-toluoyl) peroxide.

Also suitable to initiate the free-radical polymerization are initiator mixtures or redox initiator systems, including: ascorbic acid/iron(II) sulfate/sodium peroxodisulfate, tert-butyl hydroperoxide/sodium disulfite, and tert-butyl hydroperoxide/sodium hydroxymethanesulfinate.

The polymerized product comprises, by weight, from about 1% to 99% of N-vinyl formamide, and from about 99% to about 1% of the vinyl amide moiety or acrylamide moiety, recognizing that blends of the moieties may be used.

The final product can be analyzed by known techniques to characterize the product. Especially preferred are the techniques of ¹³C nuclear magnetic resonance (NMR) spectroscopy, gas chromatography (GC), and gel permeation chromatography (GPC) in order to decipher polymer identity, residual monomer concentrations, polymer molecular weight, and polymer molecular weight distribution.

Nuclear magnetic resonance (NMR) spectroscopy is an especially preferred method to probe the polymerization product in terms of chemical properties such as monomeric composition, sequencing and tacticity. Analytical equipment suitable for these analyses include the Inova 400-MR NMR System by Varian Inc. (Palo Alto, Calif.). References broadly describing NMR include: Yoder, C. H. and Schaeffer Jr., C. D., Introduction to Multinuclear NMR, The Benjamin/Cummings Publishing Company, Inc., 1987; and Silverstein, R. M., et al., Spectrometric Identification of Organic Compounds, John Wiley & Sons, 1981, which are incorporated in their entirety by reference.

Residual monomer levels can be measured by GC, which can be used to indicate the extent of reactant conversion by the polymerization process. GC analytical equipment to perform these tests are commercially available, and include the following units: Series 5880, 5890, and 6890 GC-FID and GC-TCD by Agilent Technologies, Inc. (Santa Clara, Calif.). GC principles are described in Modern Practice of Gas Chromatography, third edition (John Wiley & Sons, 1995) by Robert L. Grob and Eugene F. Barry, which is hereby incorporated in its entirety by reference.

GPC is an analytical method that separates molecules based on their hydrodynamic volume (or size) in solution of the mobile phase, such as hydroalcoholic solutions with surfactants. GPC is a preferred method for measuring polymer molecular weight distributions. This technique can be performed on known analytical equipment sold for this purpose, and include the TDAmax™ Elevated Temperature GPC System and the RImax™ Conventional Calibration System by Viscotek™ Corp. (Houston, Tex.). In addition, GPC employs analytical standards as a reference, of which a plurality of narrow-distribution polyethylene glycol and polyethylene oxide standards representing a wide range in molecular weight is the preferred. These analytical standards are available for purchase from Rohm & Haas Company (Philadelphia, Pa.) and Varian Inc. (Palo Alto, Calif.). GPC is described in the following texts, which are hereby incorporated in their entirety by reference: Schroder, E., et al., Polymer Characterization, Hanser Publishers, 1989; Billingham, N.C., Molar Mass Measurements in Polymer Science, Halsted Press, 1979; and Billmeyer, F., Textbook of Polymer Science, Wiley Interscience, 1984.

### Polymer Uses

As the polymers of the invention express many desirable properties, such as high cloud point, corrosion inhibition, and solubility potential, they may find application in many different arts, including (but not limited to): oilfield operations, gas hydrate inhibition, other performance chemicals applications, and personal care use. Application of the polymers in these arts is enabled by a number of factors, such as the proper ratio of N-vinyl formamide to aforementioned vinyl amide moiety and/or acrylamide moiety, the choice of polymerization reaction solvent, polymer molecular weight, polymer molecular weight distribution, polymer delivery vehicle, and added formulary ingredients.

A preferred use of the polymers is in oilfield operations, especially as a gas hydrate inhibitor and/or corrosion inhibitor. Typical of such compounds, it may be desirable to formulate the polymers with additional ingredients to enhance their delivery and/or performance. Materials like biocides, corrosion inhibitors, emulsifiers, de-emulsifiers, defoamers, lubricants, rheology modifiers, and shale swelling inhibitors are examples of compounds that may be combined with the invention's polymers.

When employed as a gas hydrate inhibitor, compositions comprising the polymer are used in an amount of about 0.1% to about 3% by weight of the composition, i.e., in admixture with the solvent system. The polymer inhibition concentration in the pipeline, i.e., the aqueous phase, is from about 0.1% to 3% by weight.

Due in part to the wide range of potential polymerizable units and reaction solvents, the described polymers may provide benefits outside of oilfield operations. These benefits may include rheology control, de-emulsification, biocidal activity, shale-swelling inhibition, scale inhibition, solubilization, wax inhibition, and deposition of actives (such as biocides or fragrances). Consequently, the polymers are expected to be useful in other performance chemicals and personal care applications. For example, the polymers may be combined with ingredient typical for adhesive, agricultural, biocide, cleaning, coating, encapsulation, or membrane use.

With respect to personal care products, additional compounds of particular interest anti-oxidants, bronzing/self-tanning agents, colorants, defoamers, emollients, fragrances, humectants, insect repellants, lower monoalcohols, lower polyols, micro- and nano-particulate UV absorbants, moisturizers, pigments, preservatives, propellants, oils, surfactants, thickeners, water, and waxes.

### EXAMPLES

### Example 1

### Poly(95% N-vinyl-ε-caprolactam-co-5% N-vinyl formamide) in ethylene glycol

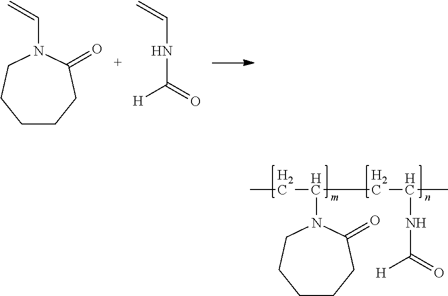

A first premix solution was prepared by stirring N-vinyl-ε-caprolactam (9.5 g) and N-vinyl formamide (0.5 g) in ethylene glycol (80 g). The reaction kettle was heated to 116° C. under nitrogen purge. After reaching temperature, Trigonox® 121 was added and the mixture stirred for 15 minutes. A second premix was prepared by stirring N-vinyl-ε-caprolactam (85.5 g) and N-vinyl formamide (4.5 g) in ethylene glycol (70 g). Over a period of 3 hours this second premix was pumped into the reaction kettle containing the first premix solution, and simultaneously, 13 charges of Trigonox® 121 (0.375 g each charge) were added to the reactor every 15 minutes. After the last charge of Trigonox® 121 the reaction kettle was cooled to 105° C., at which point an additional Trigonox® 121 charge (0.375 g) was added into the reaction kettle. Thirty minutes later, another charge of Trigonox® 121 (0.375 g) was added to the reaction kettle and the temperature was held for 1 hour. Thereafter, the reaction kettle was allowed to cool to room temperature. A brown, viscous polymer was discharged from the reaction kettle.

The polymer was analyzed by ¹³C nuclear magnetic resonance (NMR) spectroscopy (Inova 400-MR, Varian Inc.), which indicated that the two monomers polymerized. As expected, the comonomer weight ratio was around 95% N-vinyl-ε-caprolactam:5% N-vinyl formamide. The ethylene glycol solvent adduct the polymer product was about 15%, as indicated by ¹³C NMR spectroscopy.

In addition, the residual monomer content in the product was analyzed by gas chromatography (GC-TCD Series 5880, Agilent Technologies), which indicated that the overall residual monomers content was less than 2% (w/w).

The polymer is a random, alternating, or block polymer. The structural subscripts “m” and “n” are integers equal to or greater than 1 such that the number of each monomer unit yields a polymer having a molecular weight between 500 amu and 5,000,000.

The weight-average molecular weight, cloud point, and gas hydrate induction time also were measured (described later).

### Example 2

### Poly(80% N-vinyl-ε-caprolactam-co-20% N-vinyl formamide) in ethylene glycol

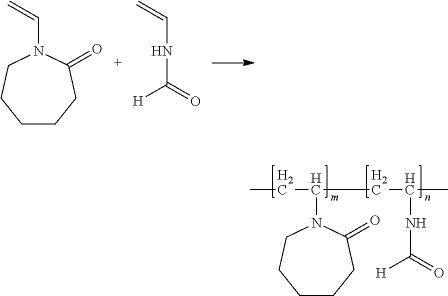

The method of Example 1 was repeated, but with the following changes. The first premix contained 8 g N-vinyl-ε-caprolactam and 2 g N-vinyl formamide in 80 g ethylene glycol. The second premix contained 72 g N-vinyl-ε-caprolactam and 18 g N-vinyl formamide in 70 g ethylene glycol. Again, a brown, viscous polymer was discharged from the reaction kettle.

The polymer is a random, alternating, or block polymer. The structural subscripts “m” and “n” are integers equal to or greater than 1 such that the number of each monomer unit yields a polymer having a molecular weight between 500 amu and 5,000,000.

The weight-average molecular weight, cloud point, and gas hydrate induction time also were measured (described later).

### Example 3

### Poly(60% N-vinyl-ε-caprolactam-co-40% N-vinyl formamide) in ethylene glycol

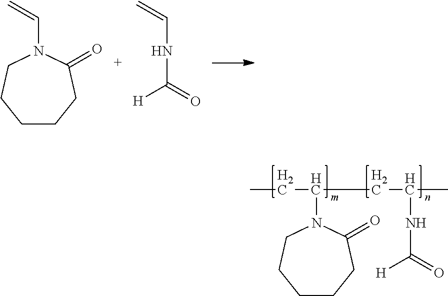

The method of Example 1 was repeated, but with the following changes. The first premix contained 6 g N-vinyl-ε-caprolactam and 4 g N-vinyl formamide in 80 g ethylene glycol. The second premix contained 54 g N-vinyl-ε-caprolactam and 36 g N-vinyl formamide in 70 g ethylene glycol. As before, a brown, viscous polymer was discharged from the reaction kettle.

The cloud point and gas hydrate induction time also were measured (described later).

The structural subscripts “m” and “n” are integers equal to or greater than 1 such that the number of each monomer unit yields a polymer having a molecular weight between 500 amu and 5,000,000.

The polymer is a random, alternating, or block polymer.

### Example 4

### Poly(50% N-vinyl-ε-caprolactam-co-50% N-vinyl formamide) in ethylene glycol

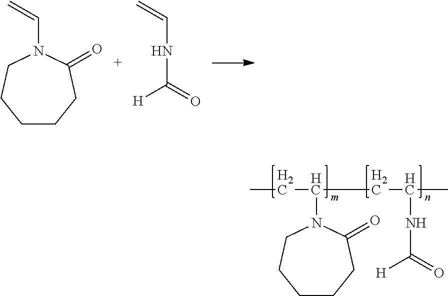

The method of Example 1 was repeated, but with the following changes. The first premix contained 5 g N-vinyl-ε-caprolactam and 5 g N-vinyl formamide in 80 g ethylene glycol. The second premix contained 45 g N-vinyl-ε-caprolactam and 45 g N-vinyl formamide in 70 g ethylene glycol. Once again, a brown, viscous polymer was discharged from the reaction kettle.

The polymer was analyzed by ¹³C NMR spectroscopy (Inova 400-MR, Varian Inc.), which indicated that the two monomers polymerized. As expected, the comonomer weight ratio was around 50% N-vinyl-ε-caprolactam:50% N-vinyl formamide.

In addition, the residual monomer content in the product was analyzed by gas chromatography (GC-TCD Series 5880, Agilent Technologies), which indicated that the overall residual monomers content was less than 2% (w/w).

The polymer is a random, alternating, or block polymer. The structural subscripts “m” and “n” are integers equal to or greater than 1 such that the number of each monomer unit yields a polymer having a molecular weight between 500 amu and 5,000,000.

The weight-average molecular weight, cloud point, and gas hydrate induction time also were measured (described later).

### Example 5

### Poly(95% N-vinyl-ε-caprolactam-co-5% N-vinyl formamide) in 2-butoxyethanol

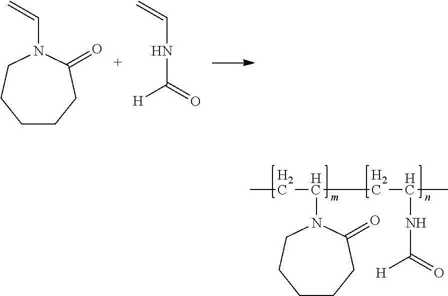

A feed solution was prepared by stirring N-vinyl-ε-caprolactam (95 g) and N-vinyl formamide (5 g) in 2-butoxyethanol (100 g). This feed solution was fed to a reaction kettle, which was heated to 150° C. under nitrogen purge and then held at this temperature for 30 minutes. Then, Trigonox® B was added, and simultaneously, the remaining feed solution was fed into the reaction kettle over a period of 2 hours. After 1 hour, additional Trigonox® B was added to the reaction kettle. Once all feed solution had entered the reaction kettle (i.e., after 2 hours), then four charges of Trigonox® B were added to the reaction kettle every 1 hour. After the final charge, the reaction kettle was maintained at 150° C. for an additional 1 hour, and then allowed to cool to room temperature. A brown, viscous polymer was discharged from the reaction kettle.

The polymer was analyzed by ¹³C NMR spectroscopy (Inova 400-MR, Varian Inc.), which indicated that the two monomers polymerized. As expected, the comonomer weight ratio was around 95% N-vinyl-ε-caprolactam:5% N-vinyl formamide.

The polymer is a random, alternating, or block polymer. The structural subscripts “m” and “n” are integers equal to or greater than 1 such that the number of each monomer unit yields a polymer having a molecular weight between 500 amu and 5,000,000.

The weight-average molecular weight, cloud point, and gas hydrate induction time also were measured (described later).

### Example 6

### Poly(80% N-vinyl-ε-caprolactam-co-20% N-vinyl formamide) in 2-butoxyethanol

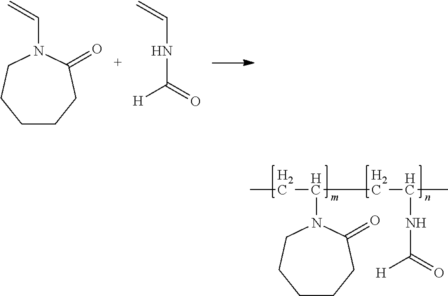

The method of Example 5 was repeated, but with the following changes. The feed solution contained 80 g N-vinyl-ε-caprolactam and 20 g N-vinyl formamide in 100 g 2-butoxyethanol. A brown, viscous polymer was discharged from the reaction kettle.

The weight-average molecular weight and gas hydrate induction time also were measured (described later). The polymer is a random, alternating, or block polymer. The structural subscripts “m” and “n” are integers equal to or greater than 1 such that the number of each monomer unit yields a polymer having a molecular weight between 500 amu and 5,000,000.

### Example 7

### Poly(50% N-vinyl-ε-caprolactam-ter-20% N-vinyl-2-pyrrolidone-ter-30% N-vinyl formamide) in ethylene glycol

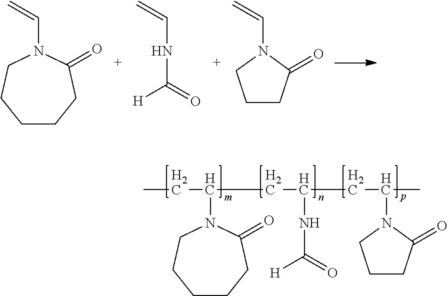

A first premix solution was prepared by stirring N-vinyl-ε-caprolactam (5 g), N-vinyl-2-pyrrolidone (2 g), and N-vinyl formamide (3 g) in ethylene glycol (80 g). The reaction kettle was heated to 116° C. under nitrogen purge. After reaching temperature, Trigonox® 121 (0.375 g) was added and the mixture stirred for 15 minutes. A second premix was prepared by stirring N-vinyl-ε-caprolactam (45 g), N-vinyl-2-pyrrolidone (18 g), and N-vinyl formamide (27 g) in ethylene glycol (70 g). Over a period of 3 hours this second premix was pumped into the reaction kettle containing the first premix solution, and simultaneously, 13 shots of Trigonox® 121 (0.375 g each charge) were added to the reactor every 15 minutes. After the last charge of Trigonox® 121 (0.375 g) the reaction kettle was cooled to 105° C., at which point Trigonox® 121 (0.375 g) was added into the reaction kettle. Thirty minutes later, another charge of Trigonox® 121 (0.375 g) was added to the reaction kettle and the temperature was held for 1 hour. Thereafter, the reaction kettle was allowed to cool to room temperature. A brown, viscous polymer was discharged from the reaction kettle.

The structural subscripts “m,” “n,” and “p” are integers equal to or greater than 1 such that the number of each monomer unit yields a polymer having a molecular weight between 500 amu and 5,000,000.

The cloud point and gas hydrate induction time also were measured (described later). The polymer is a random, alternating, or block polymer.

### Example 8

### Poly(50% N-vinyl-ε-caprolactam-ter-30% N-vinyl-2-pyrrolidone-ter-20% N-vinyl formamide) in ethylene glycol

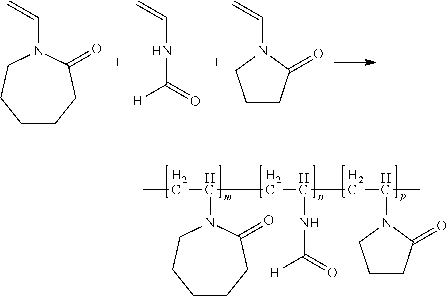

The method of Example 7 was repeated, but with the following changes. The first premix contained 5 g N-vinyl-ε-caprolactam, 3 g N-vinyl-2-pyrrolidone, and 2 g N-vinyl formamide in 80 g ethylene glycol. The second premix contained 45 g N-vinyl-ε-caprolactam, 27 g N-vinyl-2-pyrrolidone, and 18 g N-vinyl formamide in 70 g ethylene glycol. A brown, viscous polymer was discharged from the reaction kettle.

The polymer was analyzed by ¹³C NMR (Inova 400-MR, Varian Inc.), which indicated that the monomers did polymerized, and the weight monomer ratio was 20% N-vinyl formamide: 80% vinyl caprolactam/vinyl pyrrolidone. The solvent adduct in the product was about 2%-3% (w/w), as indicated by ¹³C NMR spectroscopy.

In addition, the residual monomer content in the product was analyzed by GC (GC-TCD Series 5880, Agilent Technologies), which indicated that the overall residual monomers content was less than 0.5% (w/w).

The polymer is a random, alternating, or block polymer. The structural subscripts “m,” “n,” and “p” are integers equal to or greater than 1 such that the number of each monomer unit yields a polymer having a molecular weight between 500 amu and 5,000,000.

The weight-average molecular weight, cloud point and gas hydrate induction time also were measured (described later).

### Example 9

### Poly(50% N-vinyl-ε-caprolactam-ter-45% N-vinyl-2-pyrrolidone-ter-5% N-vinyl formamide) in ethylene glycol

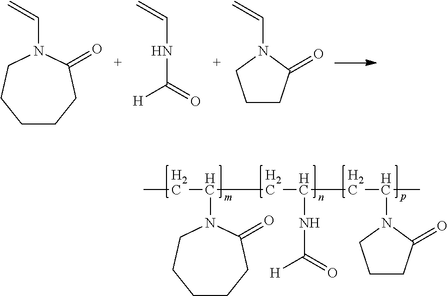

The method of Example 7 was repeated, but with the following changes. The first premix contained 5 g N-vinyl-ε-caprolactam, 4 g N-vinyl-2-pyrrolidone, and 0.5 g N-vinyl formamide in 80 g ethylene glycol. The second premix contained 45 g N-vinyl-ε-caprolactam, 36 g N-vinyl-2-pyrrolidone, and 4.5 g N-vinyl formamide in 80 g ethylene glycol. A brown, viscous polymer was discharged from the reaction kettle.

The polymer is a random, alternating, or block polymer. The structural subscripts “m,” “n,” and “p” are integers equal to or greater than 1 such that the number of each monomer unit yields a polymer having a molecular weight between 500 amu and 5,000,000.

### Method 1: Measurement of Weight-Average Molecular Weight.

The following GPC method was used to analyze the molecular weight distributions of the polymeric products of this invention:
1. A GPC mobile phase was prepared of 50% methanol:50% distilled water with 0.4 M lithium nitrate buffered to pH 9 using 0.1 M 2-amino-2-hydroxymethyl-propane-1,3-diol (tris).
2. A 0.15% solution of the polymerization product was made in the GPC mobile phase and mixed on a rotating wheel at about 20 rpm until clear.
3. The dissolved solution was filtered through a 0.45 μm polyvinylidene fluoride filter (Millex® HV, Millipore Corp., Billerica, Mass.).
4. The GPC system was equipped with a 515 HPLC pump (Waters Corp., Milford, Mass.), a Waters 2414 differential refractive index detector (Waters Corp.), and a two-column set (Toro Haas G3000, and Shodex KB803) operated at 30° C.
5. Polyethylene glycol (PEG) and polyethylene oxide (PEO) standards were injected as molecular weight references both before and after sample analyses. Six PEG standards were used: 194; 640; 1,080; 4,120; 11,840; 22,800 amu (Varian Inc., Palo Alto, Calif.). Five PEO standards were used: 43,000; 101,000; 540,000; and 879,000 amu (Rohm & Haas Company, Philadelphia, Pa.), and 1,345,000 amu (Varian Inc., Palo Alto, Calif.).
6. After analyzing the analytical references, the polymerization products were injected and evaluated in terms of weight-average molecular weight, [symbol] M_{w} [symbol] , and polydispersity index (PDI), defined as:

$$PDI = \frac{〈 {M}_{w} 〉}{〈 {M}_{n} 〉}$$

where [symbol] Mₙ [symbol] is the number average molecular weight.

### Examples 10-16

Method 1 was employed to measure [symbol] M_{w} [symbol] and PDI for the polymerization products of Examples 1, 4, 5, 6, and 8.

The weight-average molecular weights were found to vary from 2,000 amu to about 15,000 amu, and the polydispersity indexes ranged from 2.2 to 6.0 (Table 1).

From [symbol] M_{w} [symbol] , the molecular weights of the specific monomer units, and the polymer compositions, the values of structural subscripts “m”, “n”, and “p” can be determined. For example, the polymer of Example 8 comprises on the order of 30 N-vinyl-ε-caprolactam units, 23 N-vinyl-2-pyrrolidone units, and 24 N-vinyl formamide units.

TABLE 1
Weight-average molecular weights for compositions of Examples 1-8.

| | | chemistry | [symbol] M_{w} [symbol] | |
|---|---|---|---|---|
| Example | composition | (weight percent) | (amu) | PDI |
| 10 | | 100 VCL:0 NVF in EG | 2,000 | 2.2 |
| 11 | Example 1 | 95 VCL:5 NVF in EG | 4,400 | 4.2 |
| 12 | Example 4 | 50 VCL:50 NVF in EG | 12,000 | 3.6 |
| 13 | | 0 VCL:100 NVF in EG | 15,000 | 3.0 |
| 14 | Example 5 | 95 VCL:5 NVF in BGE | 5,320 | 6.0 |
| 15 | Example 6 | 80 VCL:20 NVF in BGE | 6,310 | 4.2 |
| 16 | Example 8 | 50 VCL:30 VP:20 NVF in | 8,460 | 3.4 |
| | | EG | | |

VCL: N-vinyl-ε-caprolactam
NVF: N-vinyl formamide
VP: N-vinyl-2-pyrrolidone
EG: ethylene glycol
BGE: 2-butoxyethanol

### Method 2: Cloud Point Measurement

The following method was used to measure the cloud point temperature:
1. A 1% (w/w) solution of the polymerization product was prepared in double distilled water in a 500 mL glass beaker. A Teflon® coated magnetic stir bar was placed in the beaker and rotated at about 200 rpm. A clear solution was produced.
2. The beaker as placed on a heating stir plate. The solution was stirred at about 200 rpm and heated at about 2° C./min.
3. A thermocouple was placed in the beaker about 2 cm from the beaker wall and about 4 cm from the beaker bottom.
4. The solution was visually observed during heating. The cloud point temperature was indicated by the first indication of hazy (i.e., not clear) solution.

### Examples 17-26

Method 2 was employed to measure the cloud point temperatures for the polymerization products of Examples 1-5, 7-9.

The cloud points was found to range from 40° C. to greater than 99° C. (i.e., solution boiled first), and were dependent on the selection of the reactants (Table 2).

TABLE 2
Cloud points for compositions of Examples 1-9.

| | | chemistry | cloud point |
|---|---|---|---|
| Example | composition | (weight percent) | (° C.) |
| 17 | | 100 VCL:0NVF in EG | 40 |
| 18 | Example 1 | 95 VCL:5NVF in EG | 40 |
| 19 | Example 2 | 80 VCL:20 NVF in EG | 42 |
| 20 | Example 3 | 60 VCL:40NVF in EG | 84 |
| 21 | Example 4 | 50 VCL:50NVF in EG | >99 |
| 22 | | 0 VCL:100NVF in EG | >99 |
| 23 | Example 5 | 95 VCL:5NVF in BGE | 40 |
| 24 | Example 7 | 50 VCL:20 VP:30 NVF in EG | >99 |
| 25 | Example 8 | 50 VCL:30 VP:20 NVF in EG | 89 |
| 26 | Example 9 | 50 VCL:45 VP:5 NVF in EG | 66 |

VCL: N-vinyl-ε-caprolactam
NVF: N-vinyl formamide
VP: N-vinyl-2-pyrrolidone
EG: ethylene glycol
BGE: 2-butoxyethanol

### Method 3: Measurement of Kinetic Gas Hydrate Inhibition

The following steps were executed to measure the kinetic gas hydrate inhibition of polymerization products of this invention:
1. A 500 mL, 316 stainless steel autoclave vessel, equipped with a thermostated cooling jacket, sapphire window, inlet and outlet ports, platinum resistance thermometer (PRT), and a magnetic stirring pellet was selected. The autoclave was rated for use between −25° C. to 400° C. Temperature and pressure data were recorded by a thermocouple and pressure transducer, respectively, and recorded by computer data acquisition software. The cell contents were visually monitored by a boroscope video camera connected to a time lapsed video recorder.
2. The rig was cleaned using prior to running blank or test solutions:
   a. An air drill with a wet emery-paper buffer head was used to passivate the interior stainless steel surface wall of the rig.
   b. The vessel was then rinsed several times with double distilled water and dried with lint-free tissue.
3. Approximately 200 g of gas hydrate inhibitor solution, made in double-distilled water, were added to the rig to produce a defined concentration (e.g., 0.5%, 0.6%, 0.75%). The rig top was replaced and tightened.
4. The solution was stirred by a magnetic stirrer at 500 rpm.
5. Then, the autoclave was purged with an experimental hydrocarbon test mixture (Green Canyon Gas) (Table 3) for 60 seconds.
6. The system was pressurized to a defined pressure (e.g., 35 bar, 60 bar) at room temperature.
7. After pressurization, the temperature was reduced from room temperature to a defined chill temperature (e.g., 4° C., 7° C.) (see step 11). The reactor pressure was maintained with Green Canyon Gas as the solution temperature was reduced.
8. The pressure and temperature data logging devices were activated.
9. The rig was maintained at the defined chill temperature and pressure until gas hydrates were detected.
10. Hydrate formation in the rig was determined by any one of three indicators: (1) visual detection of hydrate crystals (i.e., non-clear solution), (2) a decrease in vessel pressure due to gas uptake by the solution, or (3) an increase in solution temperature created by the exothermic gas hydrate reaction.
11. A commercial software package, pvtsim (Calsep A/S, Lyngby, Denmark) was used to predict the Green Canyon Gas equilibrium melting temperature. For test pressures of 35 bar and 60 bar, the equilibrium melting temperatures are about 13.5° C. and 17.3° C., respectively. The kinetic gas hydrate inhibition tests were conducted 35 bar and 4° C.; and 60 bar and 7° C. in order to create subcooling temperatures of 9.5° C. and 10.3° C., respectively. (Subcooling temperature is the difference between the equilibrium melting temperature and the experimental fluid temperature.)

TABLE 3
Composition of the experimental hydrocarbon gas mixture composition.

| | amount |
|---|---|
| component | (molar percent) |
| nitrogen | 0.39 |
| methane | 87.26 |
| ethane | 7.57 |
| propane | 3.10 |
| iso-butane | 0.49 |
| N-butane | 0.79 |
| iso-pentane | 0.20 |
| N-pentane | 0.20 |
| total | 100.00 |

Gas hydrate inhibition efficiency is proportional to the induction time, which is the time from the start of the run (viz., step 8) to the time when gas hydrates are detected (viz., step 10).

### Examples 27-36

The induction time was measured using Method 3 for two blank solutions (i.e., containing no gas hydrate inhibitor) and the compositions of Example 1-8.

These polymers exhibit excellent gas hydrate inhibition, as the induction times were in excess of 48 hours (Table 4).

TABLE 4
Gas hydrate induction times for gas hydrate inhibitors of Example 1-8.

| | | | | test conditions | | |
|---|---|---|---|---|---|---|
| | | | | subcooling | | average |
| | | chemistry | pressure | temperature | use level | induction time |
| Example | inhibitor | (weight percent) | (bar) | (° C.) | (%) | (h) |
| 27 | none | blank | 60 | 10.3 | 0 | 0 |
| 28 | none | blank | 35 | 9.5 | 0 | 0 |
| 29 | Example 3 | 60 VCL: 40 NVF in EG | 60 | 10.3 | 0.6 | >48 |
| 30 | Example 4 | 50 VCL: 50 NVF in EG | 60 | 10.3 | 0.6 | >48 |
| 31 | Example 5 | 95 VCL: 5 NVF in BGE | 60 | 10.3 | 0.6 | >48 |
| 32 | Example 5 | 95 VCL: 5 NVF in BGE | 35 | 9.5 | 0.5 | >48 |
| 33 | Example 6 | 80 VCL: 20 NVF in BGE | 35 | 9.5 | 0.6 | >48 |
| 34 | Example 7 | 50 VCL: 20 VP: 30 NVF in EG | 60 | 10.3 | 0.75 | >48 |
| 35 | Example 8 | 50 VCL: 30 VP: 20 NVF in EG | 60 | 10.3 | 0.6 | >48 |
| 36 | Example 8 | 50 VCL: 30 VP: 20 NVF in EG | 60 | 10.3 | 0.75 | >96 |

VCL: N-vinyl-ε-caprolactam
NVF: N-vinyl formamide
VP: N-vinyl-2-pyrrolidone
EG: ethylene glycol
BGE: 2-butoxyethanol

### Method 4: Evaluation of Corrosion Inhibition

Corrosion inhibition tests were conducted under dynamics condition of high shear stress using the following method:
1. The corrosion test apparatus consisted of a 100-mL jacket test vessel fitted with gas inlet and outlet ports, and a rotating electrode connected to an electrochemical test system.
2. The test vessel was filled with 100 g of a test solution consisting of 3% NaCl in double distilled water, or 3% NaCl solution with 50 parts-per-million (ppm) corrosion inhibitor.
3. Then, the test solution was purged with nitrogen at least for 30 minutes to remove oxygen. At the same time, the temperature of the test solution was heated to 30° C.
4. A cylindrical, 1018-carbon steel coupon was degreased by submersing it into hexane for 5 minutes, followed by acetone submersion for 5 minutes. The coupon was removed, dried, and then polished using 1,200-grade silicon carbide paper, and then rinsed in double distilled water. Afterward, it was dried in an oven at 35° C.
5. This pretreated metal coupon was mounted on the shaft of the rotating cylinder electrode and inserted into the test solution. The electrode rotated at 1000 rpm for a total time of approximately 2 hours.
6. A linear polarization resistance technique was used to determine the corrosion rate (CR), and data were collected at 30-minute intervals for up to 2 hours.
7. The inhibitory efficiency (IE) was determined using the following equation:

$$IE = \frac{{CR}_{no inhibitor} - {CR}_{w . inhibitor}}{{CR}_{no inhibitor}} \times 100$$

where:
CR_{no inhibitor}=corrosion rate in absence of an inhibitor
CR_{w inhibitor}=corrosion rate in the presence of the inhibitor

### Examples 37-39

Method 4 was used to characterize two compositions of the current invention.

Excellent corrosion inhibition was measured over a wide range of N-vinyl-ε-caprolactam:N-vinyl formamide ratio (Table 5).

TABLE 5
Corrosion inhibitory efficiencies for N-vinyl-ε-caprolactam:N-vinyl
formamide copolymers.

| | | | average |
|---|---|---|---|
| | | chemistry | inhibitory |
| Example | inhibitor | (weight percent) | efficiency |
| 37 | none | blank | 0% |
| 38 | Example 1 | 95 VCL:5 NVF in EG | 82% |
| 39 | Example 4 | 50 VCL:50 NVF in EG | 92% |

VCL: N-vinyl-ε-caprolactam
NVF: N-vinyl formamide
EG: ethylene glycol

The invention has been described in detail with particular reference to preferred embodiments thereof, but it will be understood that variations and modifications can be effected within the spirit and scope of the invention.

What is claimed is:

1. A polymer derived from at least (A) N-vinyl formamide, (B) one vinyl amide moiety or one acrylamide moiety, and (C) a reaction solvent.

2. The polymer of claim 1 wherein said vinyl amide moiety and said acrylamide moiety are selected from the group consisting of: N-vinyl pyrrolidone; N-vinyl piperidone; N-vinyl caprolactam; N-vinyl-3-methylpyrrolidone; N-vinyl-4-methylpyrrolidone; N-vinyl-5-methyl pyrrolidone; N-vinyl-3-ethyl pyrrolidone; N-vinyl-3-butyl pyrrolidone; N-vinyl-3,3-dimethyl pyrrolidone; N-vinyl-4,5-dimethyl pyrrolidone; N-vinyl-5,5-dimethyl pyrrolidone; N-vinyl-3,3,5-trimethyl pyrrolidone; N-vinyl-5-methyl-5-ethyl pyrrolidone; N-vinyl-3,4,5-trimethyl-3-ethyl pyrrolidone; N-vinyl-6-methyl-2-piperidone; N-vinyl-6-ethyl-2-piperidone; N-vinyl-3,5-dimethyl-2-piperidone; N-vinyl-4,4-dimethyl-2-piperidone; N-vinyl-6-propyl-2-piperidone; N-vinyl-3-octyl piperidone; N-vinyl-7-methyl caprolactam; N-vinyl-7-ethyl caprolactam; N-vinyl-4-isopropyl caprolactam; N-vinyl-5-isopropyl caprolactam; N-vinyl-4-butyl caprolactam; N-vinyl-5-butyl caprolactam; N-vinyl-4-butyl caprolactam; N-vinyl-5-tert-butyl caprolactam; N-vinyl-4-octyl caprolactam; N-vinyl-5-tert-octyl caprolactam; N-vinyl-4-nonyl caprolactam; N-vinyl-5-tert-nonyl caprolactam; N-vinyl-3,7-dimethyl caprolactam; N-vinyl-3,5-dimethyl caprolactam; N-vinyl-4,6-dimethyl caprolactam; N-vinyl-3,5,7-trimethyl caprolactam; N-vinyl-2-methyl-4-isopropyl caprolactam; N-vinyl-5-isopropyl-7-methyl caprolactam; N-vinyl formamide; N-vinyl acetamide, N-(2,2-dichloro-vinyl)-propionamide; N-ethenyl acetamide; cis-N-propenyl acetamide; N-vinyl-N-methyl acetamide; N-vinyl-N,N-propyl propionamide; N-acryloyl piperidone, N-acryloyl pyrrolidone, ethyl acryloyl pyrrolidone, methyl acryloyl pyrrolidone, N-acryloyl caprolactam, ethyl acryloyl caprolactam, methyl acryloyl caprolactam, N-cyclohexylacrylamide, N-cyclopentylacrylamide, acrylamide, N-butoxymethylacrylamide; N,N-dibutylacrylamide; N-butylacrylamide; diacetoneacrylamide; N—(N,N-dimethylamino)ethyl acrylamide; N,N-diethylacrylamide; N,N-dimethylaerylamide; N-dodecylmethacrylamide; N-ethylacrylamide; N-ethylmethacrylamide; N-isopropylacrylamide; N-isopropylmethacrylamide; β,β-N,N-tetramethylacrylamide; N-methylolacrylamide; N-methyl acrylamide; N-octadecylacrylamide; N-octylacrylamide; N-phenylacrylamide; trichloroacrylamide; and blends thereof.

3. The polymer of claim 1 that comprises, by weight, about 1%-99% of said N-vinyl formamide and about 1%-99% of said vinyl amide moiety or said acrylamide moiety.

4. The polymer of claim 1 wherein said reaction solvent is selected from the group consisting of alcohols, glycol ethers, thiols, and blends thereof.

5. The polymer of claim 1 wherein said reaction solvent is selected from the group consisting of: 2-butoxyethanol, 2-ethoxyethanol, ethylene glycol, 2-methoxyethanol, propylene glycol, 2-propoxyethanol, methanol, ethanol, 1-propanol, 2-propanol, n-butanol, isobutanol, sec-butanol, tert-butanol, 1-pentanol, 3-methyl-1-butanol, 2-methyl-1-butanol, 2,2-dimethyl-1-propanol, 2-pentanol, 3-pentanol, 3-methyl-2-butanol, 2-methyl-2-butanol, cyclohexanol, N-hydroxyethyl-2-pyrrolidone, N-hydroxymethyl caprolactam, and blends thereof.

6. The polymer of claim 5 that comprises N-vinyl formamide and N-vinyl-ε-caprolactam, synthesized in ethylene glycol and/or 2-butoxyethanol.

7. The polymer of claim 6 that further comprises N-vinyl-2-pyrrolidone.

8. The polymer of claim 7 that comprises about 20% N-vinyl formamide, about 50% N-vinyl-ε-caprolactam, and about 30% N-vinyl-2-pyrrolidone.

9. The polymer of claim 1 possessing a cloud point temperature greater than about 66° C.

10. The polymer of claim 1 having a molecular weight from about 500 amu to about 5,000,000 amu.

11. A composition comprising a polymer derived from at least (A) N-vinyl formamide, (B) one vinyl amide moiety or one acrylamide moiety, and (C) a reaction solvent.

12. The composition of claim 11 that further comprises an ingredient selected from the group consisting of: biocides, corrosion inhibitors, emulsifiers, de-emulsifiers, defoamers, lubricants, rheology modifiers, shale swelling inhibitors, solvents, and blends thereof.

13. The composition of claim 11 used to prevent, retard, and/or reduce the formation and/or growth of gas hydrates, or prevent, retard, and/or reduce corrosion during the transport of a fluid comprising water and a hydrocarbon through a conduit.

14. The composition of claim 11 wherein said polymer comprises N-vinyl formamide and N-vinyl-ε-caprolactam, synthesized in ethylene glycol and/or 2-butoxyethanol.

15. The composition of claim 14 wherein said polymer further comprises N-vinyl-2-pyrrolidone.

16. The composition of claim 12 wherein said solvent is selected from the group consisting of 1-butanol, 2-butanol, ethanol, ethylene glycol, methanol, 1-propanol, 2-propanol, and propylene glycol, 2-butoxyethanol, 2-ethoxyethanol, 2-isopropoxyethanol, 2-methoxyethanol, 2-propoxyethanol, tetrahydrofuran, N-methyl-2-pyrrolidone, N-hydroxyethyl-2-pyrrolidone, N-hydroxymethyl-2-caprolactam, 2-pyrrolidone, ε-caprolactam, water, and blends thereof.

17. A method preventing, retarding, and/or reducing the formation and/or growth of gas hydrates or for preventing, retarding, and/or reducing corrosion during the transport of a fluid comprising water and a hydrocarbon through a conduit which comprises the addition into an aqueous phase a composition comprising polymer derived from at least (A) N-vinyl formamide, (B) one vinyl amide moiety or one acrylamide moiety, and (C) a reaction solvent.

18. The method of claim 17 wherein said polymer comprises N-vinyl formamide and N-vinyl-ε-caprolactam, synthesized in ethylene glycol and/or 2-butoxyethanol.

19. The method of claim 18 wherein said polymer further comprises N-vinyl-2-pyrrolidone.

20. The method of claim 17 wherein the addition rate of said polymer is between 0.01% and 5% (w/w) in said aqueous phase.

21. A personal care composition or a performance chemicals composition comprising a polymer derived from at least (A) N-vinyl formamide, (B) one vinyl amide moiety or one acrylamide moiety, and (C) a reaction solvent.
